(19) United States
(12) Patent Application Publication
(10) Pub. No.: US 2021/0159557 A1
(43) Pub. Date: May 27, 2021

(54) BATTERY CHARGE AND DISCHARGE TEMPERATURE CONTROL SYSTEM

(71) Applicant: Alan C. Knudson, Colorado City, AZ (US)

(72) Inventor: Alan C. Knudson, Colorado City, AZ (US)

(21) Appl. No.: 17/103,740

(22) Filed: Nov. 24, 2020

Related U.S. Application Data
(60) Provisional application No. 62/940,132, filed on Nov. 25, 2019.
(60) Provisional application No. 62/960,318, filed on Jan. 13, 2020.
(60) Provisional application No. 62/994,430, filed on Mar. 25, 2020.

(51) Int. Cl. H01M 10/633; H01M 10/44; H02J 7/00

(52) U.S. Cl. CPC H01M 10/633; H02J 7/005; H02J 7/0048; H01M 10/44

(57) ABSTRACT

The present disclosure relates to a battery management system and method that improves the life span of a battery using various temperatures. In one example, the lifespan of a battery is optimized by: heating a battery as it begins to charge; once a battery has reached a full charge, cooling the battery as low as possible while it isn't charging (i.e., full battery); if a battery is fully-discharged, no cooling is required; however, partially charged batteries need cooling to reduce aging. As the batteries age, the temperature at which they charge needs to increase. If the battery temperature cannot be raised, the charge current should be divided in half above 60% State of Charge.

### CROSS-REFERENCE TO RELATED APPLICATIONS

This application claims the benefit of U.S. Provisional Application Ser. No. 62/940,132, filed on Nov. 25, 2019; U.S. Provisional Application Ser. No. 62/960,318, filed on Jan. 13, 2020; and U.S. Provisional Application Ser. No. 62/994,430, filed on Mar. 25, 2020, all of which are incorporated herein by reference.

### TECHNICAL FIELD

The present disclosure relates to a battery management system. More particularly, the present disclosure relates to a battery management system that improves the life span of a battery using various temperatures.

### BACKGROUND

Power consumption continues to increase, with the demand for batteries and battery systems increasing as a result. Due to this increase in energy consumption, companies continue to add battery systems to their goods and services. A good example of this is the recent proliferation of large-scale solar and battery fields. Large-scale solar developers are an obvious buyer and integrator of large-scale battery systems. Solar shines from 8 a.m. to 6 p.m. with most of its production coming between 10:30 a.m. and 3:30 p.m. However, grid consumption peaks at 6 a.m. to 9:00 a.m. and then again at 4:00 p.m. to 9:00 p.m. Because there is little overlap in the timing, this has led to a massive drop in electricity prices during the day for solar and a need to store mid-day energy for use during peak hours.

Often, solar panel fields will be shut off completely during the middle of the day as they flood the power lines with more solar power than they can reasonably use. This, combined with the massive reduction in cost and increase in performance of Lithium Ion Batteries in the last five years, has made it economically viable to add large battery facilities to help integrate renewable energy into the grid by shifting the solar mid-day production into the morning and afternoon hours.

Batteries are typically rated for 3,000-5,000 cycles (a full charge and discharge) at a given rate of charge called C-Rate (read current) and a given temperature (typically 18-25 degrees Celsius). Manufacturers often require these operating ranges to honor a warranty on the battery. Large scale solar developers take these ratings at face value, and design battery facilities based around those battery expectations.

As large storage developers add batteries to their systems, they have to find a customer. The customer is almost always a grid operator of a utility company. The utility company has to be able to understand, in very simple terms, why they are buying the battery, what they get from it, and how much they are paying. However, a) batteries are extremely complex, b) the way they degrade is nuanced and complicated, and c) the roles of temperature, state of charge, depth of discharge, internal resistance, and end of life conditions are completely ignored.

Batteries age due to solid electrolyte interface (SEI) and lithium plating. Temperature can drastically change the life of a battery by reducing lithium plating, among other things. For example, cold temperatures early in the battery life slow down aging; however, cold temperatures during charging lead to lithium plating, which causes issues in the battery. Lithium plating must be vigilantly protected against, identified early, and avoided.

Current practice in the art is to keep the temperature of the batteries static and to add capacity to the batteries as needed to maintain working relationships, rather than prevent battery failures. As a result, a battery may last 10 years, which falls significantly short of its potential.

Accordingly, there is a need to reduce aging of a battery, extend the battery life, and reduce overall cost of use by controlling the temperature of the battery to limit lithium plating and other factors. The present invention seeks to solve these and other problems.

### SUMMARY OF EXAMPLE EMBODIMENTS

In one embodiment, a battery charge and discharge temperature control system (referred to herein as the “temperature control system”) prolongs and optimizes a battery's life by varying the temperature of the battery. In one embodiment, the temperature control system cools the battery, in the initial stages of the battery's life, to slow down aging. Once the battery begins its charge, the temperature is increased. After the battery has reached a full charge, the battery is cooled as low as possible while it is not charging. If the battery is fully-discharged, no cooling is required. On the other hand, when the battery is partially charged, the temperature is reduced to slow aging.

In one embodiment, a method of prolonging the life of a battery comprises dynamically adjusting the temperature of the battery during specific phases. For example, the temperature of a newer batter may be maintained at a colder temperature (e.g., between 5-20 degrees C.); an older battery may be heated (e.g., to between 35-40 degrees C.) during charge and cooled (e.g., to 10 degrees C.) when holding state of charge (“SoC”) and then be allowed to return to room temperature as discharging begins. Lithium plating can be monitored using charge and discharge cycles of the battery.

In one embodiment, a method of prolonging the life of a battery comprises predicting the duty cycle based on the C-rate for charging the battery and the age/relative degradation of the battery, and determining and setting the temperature of the battery as low as possible to allow charging without inducing lithium plating. The method also comprises tracking the battery discharge and charge profiles to detect signs of lithium plating. If lithium plating is detected, adjusting to a higher charging temperature for all future similar duty cycles. As lithium starts plating, there are generally three choices to save the battery from dying: 1) reduce current, 2) limit SoC below 60% (or other determined threshold), or 3) increase temperature during charge and decrease during a hold state. High SoC, high current, and battery degradation are risk factors for lithium plating.

### BRIEF DESCRIPTION OF THE DRAWINGS

FIG. 1 illustrates a flow chart of a temperature control system; and

FIG. 2 illustrates a flowchart for charging aged batteries using a temperature control system; and

FIG. 3 illustrates a flowchart for charging batteries using a temperature control system when lithium plating is detected.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need to reduce aging of a battery, extend the battery life, and reduce overall cost of use by controlling the temperature of the battery.

Temperature plays a large role in extending the life of a battery. For example, when batteries are kept cold early in their life, the aging process is slowed. However, if the battery is in cold temperatures during charging, lithium plating may follow, which will decrease the life of the battery. Preventing lithium plating in batteries is a major part of prolonging the life of the battery. When lithium plating occurs in a battery, it is often caused by increased resistance in the battery due to solid electrolyte interphase (SEI) layers—in other words, as the SEI layers grow, the resistance increases. It is the lithium plating that must be avoided if a battery is to have a prolonged life. New, fresh batteries do not have lithium plating issues. However, a drop in temperature will increase the internal resistance of the battery, leading to lithium plating.

There have been attempts by many people to solve this issue. For example, a few tried to optimize the depth of discharge (DOD); however, this alone fails to extend the battery life sufficiently. In contrast, the present disclosure relates to optimizing temperature resistance growth by programmatically avoiding temperature changes in the battery and using various temperatures to aid the performance and lifespan of the battery. The temperature control system described herein regulates the temperature at all stages of a battery's life. Vigilantly tracking the temperature during a battery's life will prolong the life of a battery. Current practice in the art is to keep the temperature of the batteries static and to add capacity to the batteries as needed to maintain working relationships rather than prevent battery failures.

In one embodiment, a battery charge and discharge temperature control system (referred to herein as the “temperature control system”) prolongs and optimizes a battery's life by varying the temperature of the battery. In one embodiment, when the battery is new, the battery is held in cold temperatures to slow aging. Once the battery is aged and begins its charge, the temperature is increased. The increase in temperature decreases the battery's internal resistance, which prevents lithium plating in the battery. After the battery has reached a full charge and is no longer charging, the battery is cooled as low as possible. If the battery is fully-discharged, no cooling is required. On the other hand, when the battery is partially charged, the temperature should be reduced to slow aging. As the batteries age, the temperature at which they charge needs to increase.

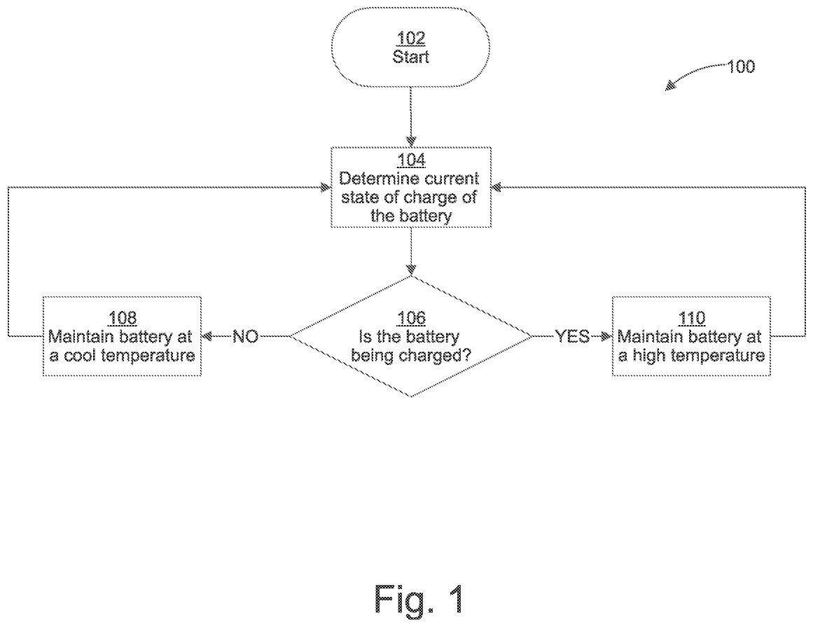

Referring to the flow chart in FIG. 1, multiple temperature cycles of a battery are depicted depending on the state of charge (SoC) of the battery as part of the temperature control system 100. At step 102, the temperature control system 100 starts. At step 104, the system determines the current state of charge of the batteries, which may be accomplished using methods known in the art, such as open circuit voltage (OCV), closed circuit voltage (CCV), hydrometers, coulomb counting, impedance spectroscopy, etc. At step 106, the system determines whether the battery is currently being charged. If the battery is not being charged (for example, if it already has a high state of charge), then at step 108, the system keeps the battery at a cool temperature, such as between 5-20 degrees Celsius. The system then loops. Referring back to step 106, if the battery is charging, then the temperature is increased (for example, to a range between 30-40 degrees Celsius), at 110, to reduce aging of the battery. After step 110, the process repeats at step 104. Heating the battery to reach the desired temperature may be accomplished using methods known in the art, such as external convective and conductive heating, as well as internal heating solutions known in the art. Likewise, known methods for cooling the battery may be used to cool to the desired temperature, such as by using liquid coolers or other methods.

In one embodiment, a method of prolonging the life of a battery comprises dynamically adjusting the temperature of the battery during specific phases. For example, the temperature of a newer battery may be maintained at a colder temperature (e.g., to 5-20 degrees C.); an older battery would be heated (e.g., to 35-40 degrees C.) during charge and cooled (e.g., to 10 degrees C.) when holding SoC, and then be allowed to return to room temperature as discharging begins. Lithium plating can be monitored using charge and discharge cycles of the battery.

In one embodiment, a method of prolonging the life of a battery comprises predicting the duty cycle based on the C-rate for charging the battery and the age/relative degradation of the battery, and determining and setting the temperature of the battery as low as possible to allow charging without inducing lithium plating. The method also comprises tracking the battery discharge and charge profiles to detect signs of lithium plating. If lithium plating is detected, adjusting the charging temperature higher for all future similar duty cycles.

It should be noted that temperature may be the only option in controlling SEI growth and, eventually, lithium plating. For example, grid capacity contracts may have batteries fully-charged and discharged, where SoC cannot vary overtime. When the temperature is regulated, internal resistance can be controlled as well as the mechanical stress that is experienced by the battery. The internal resistance and mechanical stress of a battery are related and connected to each other. When the temperature of the battery is increased, the internal resistance and the mechanical stress of the battery is reduced.

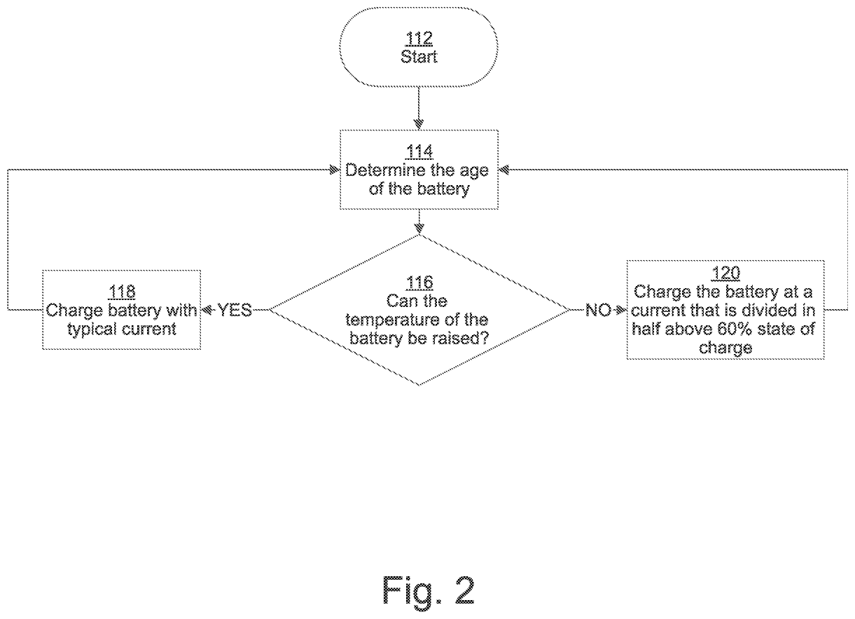

As a battery ages, the temperature needs to increase when charging. As shown in the flowchart of FIG. 2, step 112 starts the process. At step 114, the age of the battery is determined. This can be accomplished by testing voltage, resistance, charge and discharge cycles, etc. At step 116, it is determined whether the temperature of the battery can be raised, reducing internal resistance and mechanical stress of the battery. If the battery temperature can be raised, then, at step 118, the battery is charged with typical current. If the temperature cannot be raised, then, at step 120, the battery is charged at a current that is divided in half above 60% SoC. By adjusting the temperature or by reducing the flow of current, mechanical stress is reduced, which prolongs the battery life.

Currently, the typical battery left at a static temperature can degrade in about 10 years. On the other hand, when the battery utilizes the temperature control system disclosed herein, the lifespan of the battery can be increased to 30 to 40 years. This can save many power companies in battery expenses. Instead of replacing batteries every 10 years, a company can keep the same batteries for 30 to 40 years. Controlling the temperature of a battery throughout its life can prolong the life of the battery by preventing battery degradation by, for example, lithium plating. Accordingly, the temperature control system disclosed herein optimizes battery performance and increases the life of the battery.

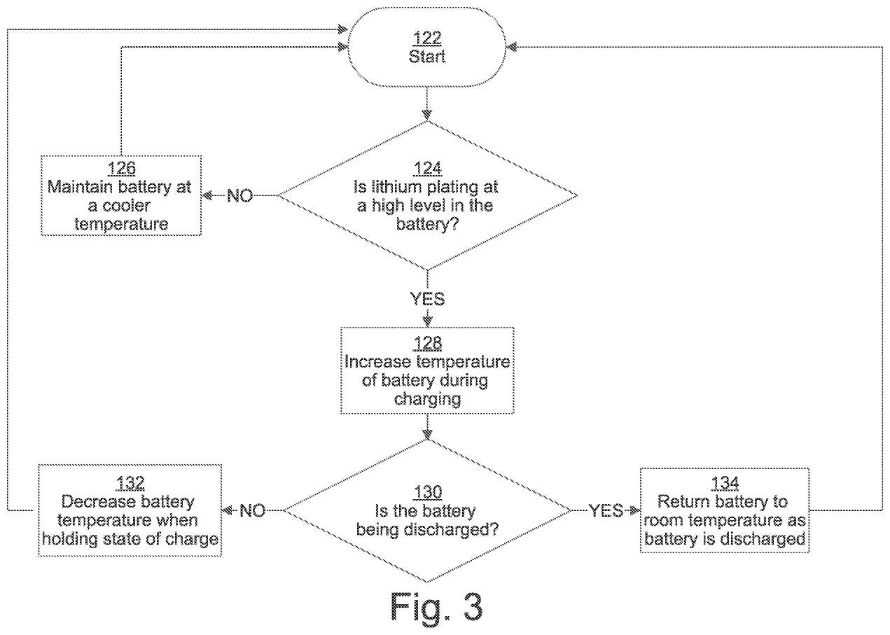

FIG. 3 illustrates a flowchart of prolonging the age of a battery by determining the level of lithium plating. The system starts at step 122 and at step 124 the level of lithium plating in the battery is determined. This may be accomplished by testing voltage, testing anode resistance, analyzing electrolyte polarization in a cell, analyzing charge/discharge cycles, analyzing electrical stripping measurements, etc. If the amount of lithium plating is low, then at step 126, the battery is maintained at a cooler temperature (e.g., 5-20 degrees C.). Often, the amount of lithium plating in a battery is determined by the age of the battery. For example, new battery may have little to no lithium plating, while older batteries may have higher levels of lithium plating. If the amount of lithium plating in the battery is high, then at step 128 the battery's temperature is increased during charging. At step 130, the system determines whether the battery is being discharged. If it is not being discharged, then at step 132, the battery's temperature is decreased to maintain SoC. If the battery is being discharged, then at step 134 the battery's temperature should be decreased to room/ambient temperature.

Therefore, the system and method of prolonging the life of a battery comprises determining the age or lithium plating of a battery and, depending upon the battery's charge/discharge state, varying the temperature to reduce additional lithium plating, thereby prolonging the life of the battery.

It will be appreciated the systems and methods described above may be carried out using processors, computers, networks, or other components. For example, the system used to prolong the life of a battery may comprise a microcontroller capable of analyzing relevant data, such as battery temperature, resistance, charge/discharge cycles, etc., and is capable of executing one or more predetermined commands based upon the analyzed data. For example, a temperature sensor may be placed on, or in, a battery so as to determine its temperature. Upon determining that the battery is outside of a predetermined threshold, the microcontroller may send signals to a heating element or a cooling element to bring the battery temperature to within the desired range, as applicable. Wireless transceivers may also be incorporated, so that the processor may be located distally from the battery location. In one embodiment, the processor may be a user's smart device, such as a smartphone or tablet.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A method of prolonging the life of a battery, comprising:
determining the state of charge of the battery;
determining whether the battery is being charged;
wherein if the battery is being charged, increasing the temperature of the battery to a predetermined range; and
wherein if the battery is not being charged, maintaining the battery within a predetermined, cooler temperature range to hold state of charge.

2. The method of claim 1, wherein the temperature is increased to a range of 30-40 degrees Celsius during charging.

3. The method of claim 1, wherein the cooler temperature range is between 5-20 degrees Celsius to maintain the state of charge.

4. A method of prolonging the life of a battery, comprising:
determining the level of lithium plating in a battery;
upon determining that lithium plating is below a predetermined threshold, maintaining the battery at a cooler temperature; and
upon determining that lithium plating is at or above a predetermined threshold:
a. increasing the temperature of the battery during charging;
b. decreasing the temperature of the battery to hold state of charge; and
c. maintaining the battery at ambient temperature during discharge.

5. The method of claim 4, wherein the temperature is increased to a range of 30-40 degrees Celsius during charging.

6. The method of claim 4, wherein the cooler temperature range is between 5-20 degrees Celsius to maintain the state of charge.

7. A method of prolonging the life of a battery, comprising:
determining the age of the battery;
determining whether the temperature of the battery can be raised;
upon determining that the temperature of the battery can be raised, charging the battery with a standard current;
upon determining that the temperature of the battery cannot be raised, charging the battery at a current that is divided in half above 60% state of charge.

8. The method of claim 7, wherein the age of the battery is determined by determining the level of lithium plating in the battery.

9. The method of claim 7, wherein the temperature is increased to a range of 30-40 degrees Celsius during charging.

10. The method of claim 7, wherein the cooler temperature range is between 5-20 degrees Celsius to maintain the state of charge.
